(19) United States
(12) Patent Application Publication
(10) Pub. No.: US 2021/0392692 A1
(43) Pub. Date: Dec. 16, 2021

(54) DYNAMIC RACH MSG1/MSGA CONFIGURATION

(71) Applicant: QUALCOMM Incorporated, San Diego, CA (US)

(72) Inventors: Iyab Issam SAKHNINI, San Diego, CA (US); Tao LUO, San Diego, CA (US)

(21) Appl. No.: 17/344,224

(22) Filed: Jun. 10, 2021

Related U.S. Application Data
(60) Provisional application No. 63/038,518, filed on Jun. 12, 2020.

(51) Int. Cl. H04W 74/08

(52) U.S. Cl. CPC H04W 74/0833

(57) ABSTRACT

A user equipment (UE) and a base station may perform a random access procedure based on a dynamic physical random access channel (PRACH) configuration. The UE may determine a first PRACH configuration, for example, based on system information. The UE may determine a second PRACH configuration, for example, based on a dynamic configuration message. The UE may determine to follow the second PRACH configuration based on a current time or the dynamic configuration message. The UE may transmit a first message of a random access (RACH) procedure based on the second PRACH configuration.

### CROSS REFERENCE TO RELATED APPLICATIONS

This application claims priority to U.S. Provisional Application No. 63/038,518 titled “DYNAMIC RACH MSG1/MSGA CONFIGURATION,” filed Jun. 12, 2020, which is assigned to the assignee hereof, and incorporated herein by reference in its entirety.

### BACKGROUND

### Technical Field

The present disclosure relates generally to communication systems, and more particularly, to a dynamic configuration of a first message in a random access procedure.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Wireless communication may include a random access (RACH) procedure that allows a user equipment (UE) to initiate or resume communications with a base station. In some scenarios, a large number of reduced capability (RedCap) and/or internet of things (IoT) devices may connect to the same cell and attempt to access the network using a RACH procedure at approximately the same time. The physical random access channel (PRACH) may become congested or overloaded, which may impact performance of the UEs.

The present disclosure provides for dynamic RACH configuration. For example, the RACH parameters for a cell may be temporarily adjusted to meet an expected demand of devices performing RACH procedures. Accordingly, the dynamic RACH configuration may reduce a rate of failed RACH procedures and improve the ability of devices to access the network.

In an aspect of the disclosure, a method, a non-transitory computer-readable medium, and an apparatus (e.g., a UE) are provided. The method may include determining a first PRACH configuration. The method may include determining a second PRACH configuration. The method may include determining to follow the second PRACH configuration based on a current time or a dynamic configuration message. The method may include transmitting a first message of a RACH procedure based on the second PRACH configuration.

In some implementations, determining the second PRACH configuration includes receiving the dynamic configuration message including a PRACH configuration update.

In some implementations, the dynamic configuration message is one of a downlink control information (DCI), media access control (MAC) control element (CE), or paging message.

In some implementations, the second PRACH configuration is valid until a second PRACH configuration update is received.

In some implementations, the second PRACH configuration is valid during a period of time indicated by the PRACH configuration update.

In some implementations, the PRACH configuration update includes a set of PRACH configuration parameters.

In some implementations, the PRACH configuration update indicates a configured PRACH configuration.

In some implementations, the first PRACH configuration and the second PRACH configuration follow a time pattern.

In some implementations, the first PRACH configuration is based on a system information block.

In some implementations, the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

In some implementations, the second PRACH configuration is for a 4-step RACH procedure or a 2-step RACH procedure.

In an aspect of the disclosure, a method, a non-transitory computer-readable medium, and an apparatus (e.g., a base station) are provided. The method may include transmitting system information indicating a first PRACH configuration. The method may include determining that a second PRACH configuration is applicable based on a current time. The method may include receiving a first message of a RACH procedure based on the second PRACH configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first 5G NR frame.

FIG. 2B is a diagram illustrating an example of DL channels within a 5G NR subframe.

FIG. 2C is a diagram illustrating an example of a second 5G NR frame.

FIG. 2D is a diagram illustrating an example of a 5G NR subframe.

FIG. 3 is a diagram illustrating an example of a base station and user equipment (UE) in an access network.

FIG. 4 is a diagram illustrating an example message exchange for a 4-step random access procedure between a base station and a UE in an access network.

FIG. 5 is a diagram illustrating an example message exchange for a 2-step random access procedure between a base station and a UE in an access network.

FIG. 6 is a flowchart of a method of wireless communication performed by a UE.

FIG. 7 is a conceptual data flow diagram illustrating the data flow between different components in an example UE.

FIG. 8 is a flowchart of a method of wireless communication performed by a base station.

FIG. 9 is a conceptual data flow diagram illustrating the data flow between different components in an example base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. The computer-readable media may be referred to as a non-transitory computer readable medium. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

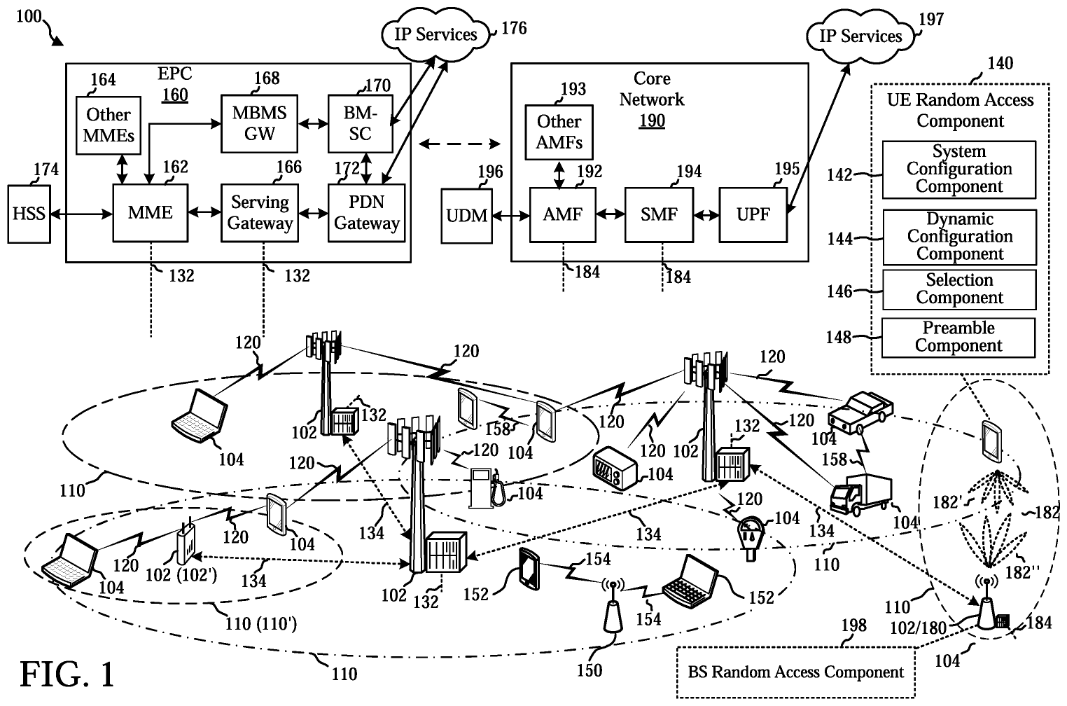

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

In certain aspects, the UE 104 may include a UE random access component 140 configured to perform a random access procedure based on dynamically configured physical random access channel (PRACH) parameters. The UE random access component 140 may include a system configuration component 142 configured to determine a first PRACH configuration. The UE random access component 140 may include a dynamic configuration component 144 configured to determine a second PRACH configuration. The UE random access component 140 may include a selection component 146 configured to determine to follow the second PRACH configuration based on a current time or a dynamic configuration message. The UE random access component 140 may include a preamble component 148 configured to transmit a first message of a RACH procedure based on the second PRACH configuration.

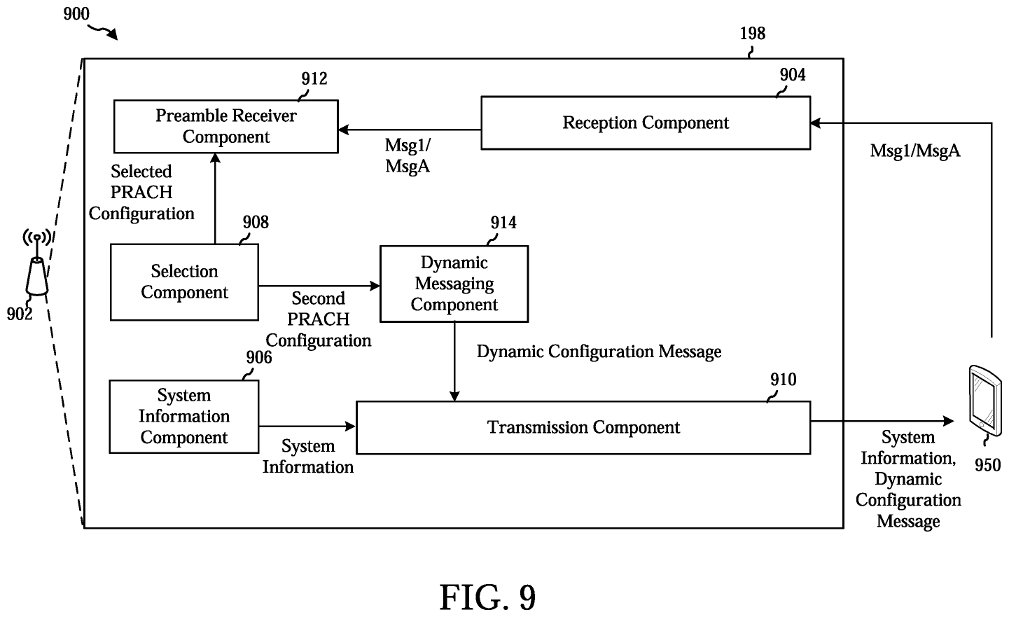

In certain aspects, one or more base stations 102/180 may include a base station (BS) random access component 198 configured to receive a first message of a RACH procedure based on a dynamic PRACH configuration. As illustrated in FIG. 9, the BS random access component 198 may include a system information component 906, a selection component 908, and a preamble receiver component 912. The system information component 906 may be configured to transmit system information indicating a first PRACH configuration. The selection component 908 may be configured to determine that a second PRACH configuration is applicable based on a current time. The preamble receiver component 912 may be configured to receive a first message of a RACH procedure based on the second PRACH configuration. The BS random access component 198 may optionally include a dynamic messaging component configured to transmit a dynamic configuration message including a PRACH configuration update in response to determining the second PRACH configuration.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies.

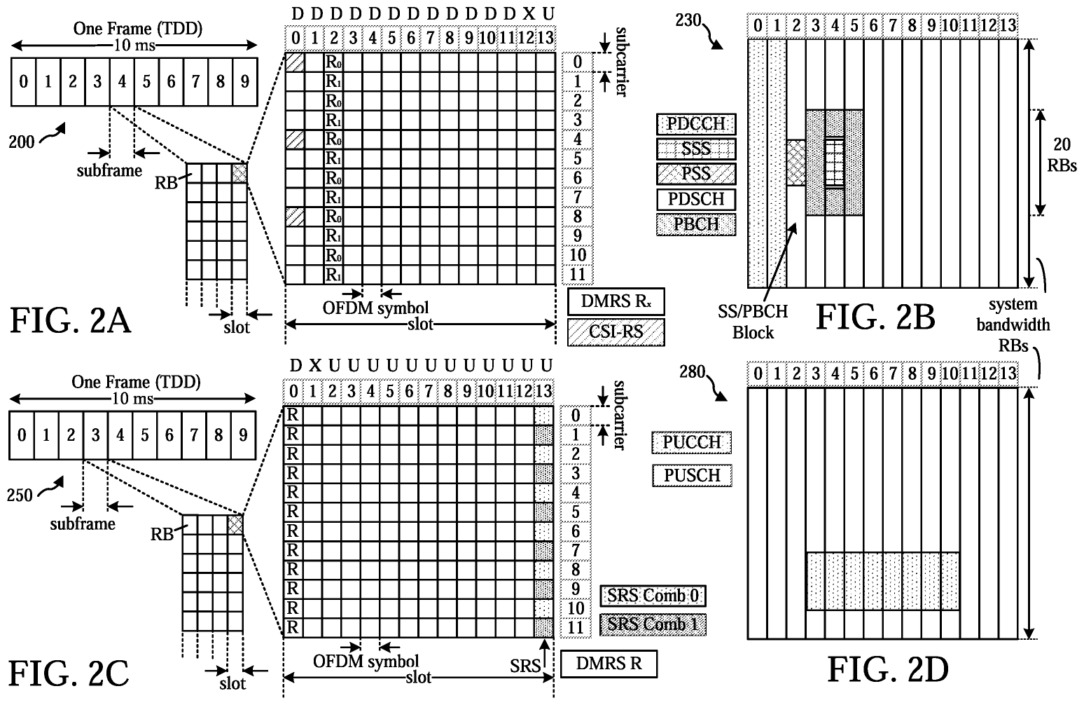

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

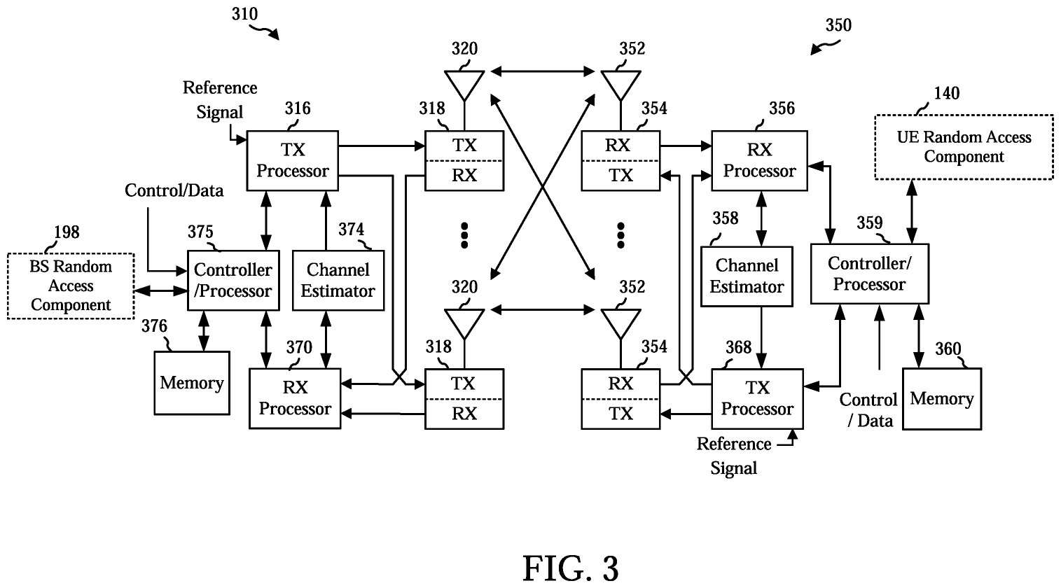

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be coupled with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be coupled with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE random access component 140 of FIG. 1.

At least one of the TX processor 316, the RX processor 370, and the controller/processor 375 may be configured to perform aspects in connection with the BS random access component198 of FIG. 1.

A reduced capability (RedCap) device and/or IoT device may be used for several scenarios including wearable devices, industrial wireless sensors, and video surveillance. Some of these scenarios may involve stationary devices. There may be a relatively large number of such devices located within a cell. More particularly, a large number of such devices may share a transmit beam of the cell. For instance, multiple devices located in close proximity may select the same SSB as the strongest transmit beam. For example, in one use case, co-located cameras or industrial sensors may be scheduled to upload data to the network at a specific time. Such devices may attempt to perform a RACH procedure using the same beam, which may overload the PRACH resources. As another example, a parking facility for personal vehicles such as bicycles or scooters may include numerous devices that attempt to access the network at particular times (e.g., rush hour).

Multiple devices attempting to concurrently perform a RACH procedure may overload RACH resources. For example, if multiple UEs select the same RACH preamble, there may be collisions and the RACH procedure may fail for one or more of the UEs. Generally, PRACH parameters are statically configured. For example, the base station may broadcast a RACH configuration via system information. For instance, each UE may acquire the cell by reading a synchronization signal block (SSB) and first system information block (SIB1). SIB1 provides initial access related parameters. In some cases, a base station may reconfigure PRACH parameters with an RRC message, but RRC signaling may not be available for UEs that are in an idle mode.

In an aspect, a base station may dynamically configure one or more UEs to temporarily use a second PRACH configuration. For example, the base station may transmit a dynamic configuration message including a PRACH configuration update. The PRACH configuration update may be valid for a specific period of time, or until another PRACH configuration update is received. The UE may determine whether to follow the first PRACH configuration or the second PRACH configuration based on, for example, a current time or a most recent dynamic configuration message. The second PRACH configuration may include one or more of: a number of RACH occasions in a frequency domain, a PRACH configuration index, a number of random access preambles, a number of contention-based preambles, or a number of SSBs per RACH occasion. Accordingly, the second PRACH configuration may be utilized to change available PRACH resources. For example, during an expected busy period, the second PRACH configuration may expand the available PRACH resources to reduce the probability of collisions, thereby reducing failure of RACH procedures.

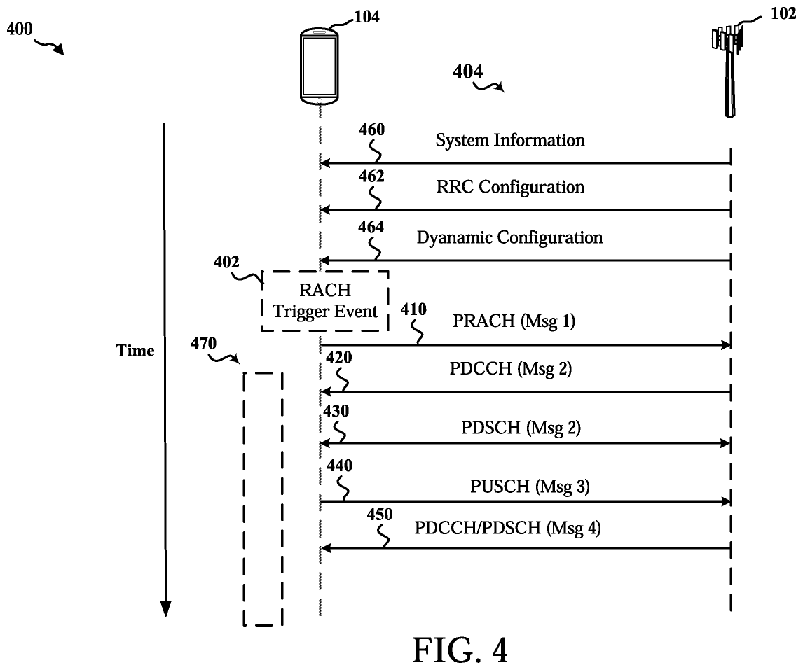

FIG. 4 is a diagram 400 illustrating an example message exchange for a 4-step RACH procedure 404 between a base station 102 and a UE 104 in an access network. The UE 104 may include a UE random access component 140. The base station 102 may include a BS random access component 198.

The UE 104 may be configured to perform the RACH procedure 404 based on a PRACH configuration. For example, the base station 102 may transmit system information 460 including a first PRACH configuration. Generally, the system information is not dynamically updated. The system information 460 may be applicable to any UE attempting to connect to the base station 102, including UEs in an idle state. Accordingly, frequent updates to the system information 460 may not be feasible.

In some implementations, the system information 460 may include a second PRACH configuration. For example, the system information 460 may include a second set of PRACH parameters that may be dynamically activated. For instance, the base station 102 may transmit the dynamic configuration message 464 to activate the second PRACH configuration. In other implementations, the second PRACH configuration may follow a pattern. For example, the pattern may specify specific times of day when the second PRACH configuration is to be followed. For instance, the pattern may indicate that the second PRACH configuration is to be used at certain busy times of day such as a rush hour at the close of business. The busy times may be determined based on a record of RACH procedures performed.

In some implementations, the base station 102 may transmit an RRC configuration 462 including one or more PRACH configuration parameters. For example, the base station 102 may transmit the RRC configuration 462 to set PRACH parameters for a particular UE. The RRC configuration 462 may be a higher layer (e.g., layer 3) message carried on a PDSCH. Accordingly, a UE 104 may need to be in a connected mode to receive the RRC configuration 462.

In some implementations, the base station 102 may transmit a dynamic configuration message 464. The dynamic configuration message 464 may be referred to as a non-RRC message. The dynamic configuration message 464 may be transmitted as a downlink control information (DCI), media access control (MAC) control element (CE), or a paging message. The dynamic configuration message 464 may include a PRACH configuration update that indicates one or more parameters of the second PRACH configuration.

The second PRACH configuration may include one or more of: a number of RACH occasions in a frequency domain, a PRACH configuration index, a number of random access preambles, a number of contention-based preambles, or a number of SSBs per RACH occasion. The number of RACH occasions in the frequency domain may define the frequency domain resources for the PRACH. The PRACH Configuration Index (e.g., a prachConfIndex parameter) may specify an index that informs the UE of which frame number and which subframe number within the frame includes PRACH resources. That is, the PRACH Configuration Index may define time domain resources for the PRACH. The number of random access preambles may be a number of preambles from which the UE may select. The number of contention-based preambles may define a subset of the number of preambles to be used for contention-based random access. The number of SSBs per RACH occasion may define which RACH occasion a UE is to use based on a selected SSB.

Referring additionally to Table 1 (below), during operation, UE 104 may execute an implementation of an NR RACH procedure 404, according to a 4-step NR RACH message flow, due to the occurrence of one or more RACH trigger events 402. Suitable examples of RACH trigger events 402 may include, but are not limited to: (i) the UE 104 performing an initial access to transition from an RRC_IDLE state to RRC_CONNECTED ACTIVE state; (ii) the UE 104 detecting downlink (DL) data arrival during while in an RRC_IDLE state or RRC_CONNECTED INACTIVE state; (iii) the UE 104 determining UL data arrival from higher layers during RRC_IDLE state or RRC__CONNECTED INACTIVE state; (iv) the UE 104 performing a handover from another station to the base station 102 during the connected mode of operation; and (v) the UE performing a connection re-establishment procedure such as a beam failure recovery procedure.

The NR RACH procedure 404 may be associated with a contention based random access procedure, or with a contention free random access procedure. In an implementation, a contention based NR RACH procedure corresponds to the following RACH trigger events 402: an initial access from RRC_IDLE to RRC_CONNECTED ACTIVE; UL data arrival during RRC_IDLE or RRC_CONNECTED INACTIVE; and a connection re-establishment. In an implementation, a contention-free NR RACH procedure corresponds to the following RACH trigger events 402: downlink (DL) data arrival during RRC_IDLE or RRC_CONNECTED INACTIVE; and, a handover during the connected mode of operation.

On the occurrence of any of the above RACH trigger events 402, the execution of the NR RACH procedure 404 may include the 4-step NR RACH message flow (see FIGS. 4 and Table 1), where UE 104 exchanges messages with one or more base stations 102 to gain access to a wireless network and establish a communication connection. The messages may be referred to as random access messages 1 to 4, RACH messages 1 to 4, or may alternatively be referred to by the PHY channel carrying the message, for example, message 3 PUSCH.

TABLE 1
NR RACH procedure, including Messages and MessageContent
transmitted over corresponding Physical (PHY) channel(s).

| PITY Channel | Message | Message content |
|---|---|---|
| PRACH | Msg1 | RACH Preamble |
| PDCCH/PDSCH | Msg2 | Detected RACH preamble ID, TA, TC- |
| | | RNTI, backoff indicator, UL/DL grants |
| PUSCH | Msg3 | RRC Connection request (or scheduling |
| | | request and tracking area update) |
| PDCCH/PDSCH | Msg4 | Contention resolution message |

Table 1: NR RACH procedure, including Messages and Message Content transmitted over corresponding Physical (PHY) channel(s).

In a first step of a first RACH procedure, for example, UE 104 may transmit a first message (Msg1) 410, which may be referred to as a random access request message, to one or more base stations 102 via a physical channel, such as a physical random access channel (PRACH). For example, Msg1 may include one or more of a RACH preamble and a resource requirement. The UE 104 may transmit the Msg1 on a random access occasion (RO). In an aspect, the RACH preamble may be a relatively long preamble sequence, which may be easier for the base station 102 to receive than an OFDM symbol. In an aspect, the UE random access component 140 may select a beam for transmission of the Msg1 based on received synchronization signal blocks (SSBs) transmitted by the base station 102. As discussed above, the second PRACH configuration may include one or more of: a number of RACH occasions in a frequency domain, a PRACH configuration index, a number of random access preambles, a number of contention-based preambles, or a number of SSBs per RACH occasion. Accordingly, the UE 104 may transmit the Msg1 410 based on the second PRACH configuration.

In a second step of the RACH procedure, the base station 102 may respond to Msg1 by transmitting a second message (Msg2), which may be referred to as a random access response (RAR) message. The RAR message may include a physical downlink control channel (PDCCH) 420 and a physical downlink shared channel (PDSCH) 430. In an aspect, the UE random access component 140 may monitor the PDCCH during a first RAR window 470 based on the first Msg1 410 to detect a PDCCH 420 of the first RAR message as a DCI format 1_0 with a CRC scrambled by a RA-RNTI corresponding to the first Msg1 410 and receive the PDSCH 430 of the RAR message as a transport block in a corresponding PDSCH within the RAR window 470.

The UE 104 may receive a transport block in a corresponding PDSCH indicated by a successfully decoded PDCCH 420. The UE 104 may decode transport block and parse the transport block for a random access preamble identity (RAPID) associated with the Msg1. For example, Msg2 may include one or more of a detected preamble identifier (ID), a timing advance (TA) value, a temporary cell radio network temporary identifier (TC-RNTI), a backoff indicator, an UL grant, and a DL grant. If the UE 104 identifies a RAPID corresponding to the Msg1 410 in the transport block, the UE 104 may identify a corresponding UL grant for Msg3. This is referred to as RAR UL grant in the physical layer.

In response to receiving Msg2, UE 104 transmits to the base station 102 a third message (Msg3) 440, which may be a RRC connection request or a scheduling request, via a physical uplink channel such as PUSCH based on the RAR UL grant provided in Msg2 of a selected serving base station 102.

In response to receiving Msg3 440, base station 102 may transmit a fourth message (Msg4) 450, which may be referred to as a contention resolution message, to UE 104 via a PDCCH and a PDSCH. For example, Msg4 may include a cell radio network temporary identifier (C-RNTI) for UE 104 to use in subsequent communications.

In some example scenarios, a collision between two or more UEs 104 requesting access can occur. For instance, two or more UEs 104 may send Msg1 having a same RACH preamble because the number of RACH preambles may be limited and may be randomly selected by each UE 104 in a contention-based NR RACH procedure. As such, each colliding UE 104 that selects the same RACH preamble will receive the same temporary C-RNTI and the same UL grant, and thus each UE 104 may send a similar Msg3. In this case, base station 102 may resolve the collision in one or more ways. In a first scenario, a respective Msg3 from each colliding UE 104 may interfere with the other Msg3, so base station 102 may not send Msg4. Then each UE 104 will retransmit Msg1 with a different RACH preamble. In a second scenario, base station 102 may successfully decode only one Msg3 and send an ACK message to the UE 104 corresponding to the successfully decoded Msg3. In a third scenario, base station 102 may successfully decode the Msg3 from each colliding UE 104, and then send a Msg4 having a contention resolution identifier (such as an identifier tied to one of the UEs) to each of the colliding UEs. Each colliding UE 104 receives the Msg4, decodes the Msg4, and determines if the UE 104 is the correct UE by successfully matching or identifying the contention resolution identifier. Such a problem may not occur in a contention-free NR RACH procedure, as in that case, base station 102 may inform UE 104 of which RACH preamble to use.

In a two-step RACH procedure, the UE transmits both RACH preamble and payload to a base station (e.g., a gNB) before receiving a random access response from the gNB. As an example, a 2-step RACH for NR may have design objectives that include: 2-step RACH shall be able to operate regardless of whether the UE has a valid timing advance (TA) or not. The 2-step RACH is applicable to any cell size supported in Rel-15 NR. In 2-step RACH, multiple messages in the 4-step RACH procedure may be combined in a single message. More specifically, MsgA combines Msg1 and Msg3 and MsgB combines Msg2 and Msg4. The MsgA may include preamble and PUSCH carrying payload where the content of MsgA includes the equivalent contents of Msg3 of 4-step RACH. The content of MsgB includes the equivalent contents of Msg2 and Msg4 of 4-step RACH. In an aspect, a second PRACH configuration may be dynamically selected for the 2-step RACH procedure. For example, the second PRACH configuration may be selected when an increased number of RACH procedures is expected.

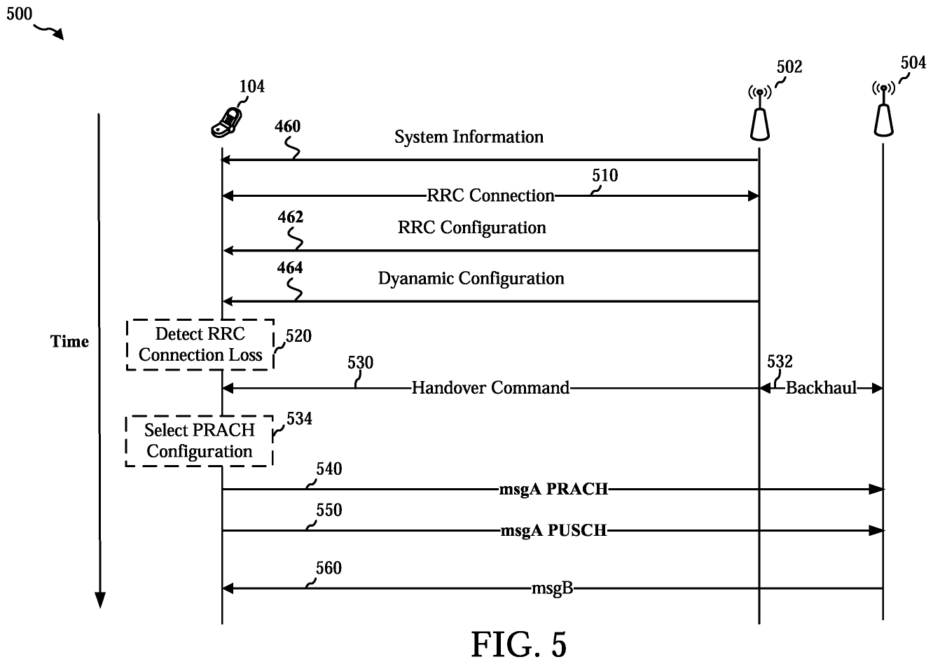

FIG. 5 is a message diagram 500 including messages that may be transmitted to establish a connection for a UE 104 to a base station 502 or a base station 504. As discussed above with respect to FIG. 4, the base station 502, which may be an example of the base station 102, may transmit system information 460 that may include at least a first RACH configuration. The UE 104 may establish an RRC connection 510 with the base station 502, for example, based on the first RACH configuration. The base station 502 may be referred to as the serving cell, pCell, or serving base station. The base station 502 may also be the pCell of a master cell group (MCG).

As discussed above, the UE 104 may receive an RRC configuration 462 including one or more PRACH parameters. As discussed above, the UE 104 may receive a dynamic configuration message 464. The dynamic configuration message 464 may include a PRACH configuration update that indicates one or more parameters of the second PRACH configuration.

At block 520, in one aspect of the present disclosure, the UE 104 may determine that the RRC connection 510 has been lost. For example, the UE 104 may detect a condition indicating that the RRC connection 510 has been lost. Example conditions include: radio link failure of the MCG, re-configuration with sync failure of the MCG, mobility from NR failure, integrity check failure, or RRC connection reconfiguration failure. In response to determining that the RRC connection 510 has been lost, the UE 104 may determine to attempt to re-establish the RRC connection 510 with the same serving cell (e.g., base station 502) or another base station (e.g., base station 504). Additionally, although a connection reestablishment scenario is illustrated in FIG. 5, the 2-step RACH procedure may be triggered by the RACH trigger event 402 discussed above regarding FIG. 4.

In another aspect of the present disclosure, the serving base station 502 may transmit a handover command 530, and the UE 104 may receive the handover command 530. The handover command 530 may instruct the UE 104 to change to the base station 504, which may be referred to as a target cell or target base station. In an aspect, the handover command 530 may include a contention free random access (CFRA) preamble that the UE 104 may use to establish a connection with the target base station 504.

In an aspect, the serving base station 502 and the target base station 504 may communicate via a backhaul 532 regarding the handover. For example, the serving base station 502 and the target base station 504 may share the CFRA preamble. The target base station 504 may reserve the CFRA preamble for the UE 104.

In response to either detecting the RRC connection loss at block 520 or receiving the handover command 530, at block 534, the UE 104 may select a PRACH configuration. For example, the UE 104 may determine that the second PRACH configuration is applicable. In some implementations, the second PRACH configuration may be applicable based on a current time being within a defined time period for the second PRACH configuration. In other implementations, the second PRACH configuration may be applicable based on a most recent dynamic configuration message 464 indicating the second PRACH configuration.

Based on the selected PRACH configuration, the UE 104 may attempt to establish a connection with one of the base station 502 or the base station 504. In the case of a handover, the target base station 504 may be indicated by the handover command 530. In the case of detecting the RRC connection loss at block 520, the UE 104 may select a strongest base station with which to re-establish the connection. In either case, the UE 104 may use a RACH procedure to establish the connection. In particular, for the 2-step RACH procedure, the UE 104 may transmit the msgA PRACH 540. The msgA PRACH 540 may be based on the selected PRACH configuration (e.g., the second PRACH configuration). For example, the UE 104 may determine one or more of: a number of RACH occasions in a frequency domain, a PRACH configuration index, a number of random access preambles, a number of contention-based preambles, or a number of SSBs per RACH occasion based on the second PRACH configuration. In an aspect, where the UE 104 has been provided with a CFRA preamble, the msgA PRACH 540 may be the CFRA preamble. Otherwise, the UE 104 may select a RACH preamble based on the RACH opportunity. The target base station 504 may receive the msgA PRACH 540.

As noted above, the 2-step RACH procedure also includes a RACH payload for the msgA. Accordingly, the UE 104 may transmit a msgA PUSCH 550 for the RACH payload. The UE 104 may transmit the msgA PUSCH 550 on resources of the target base station 504 designated for the RACH msgA PUSCH 550. The target base station 504 may receive the RACH msgA PUSCH 550.

The target base station 504 may transmit the msgB 560 to complete the 2-step RACH procedure. For example, the base station 504 may transmit the msgB 560 on the PDSCH.

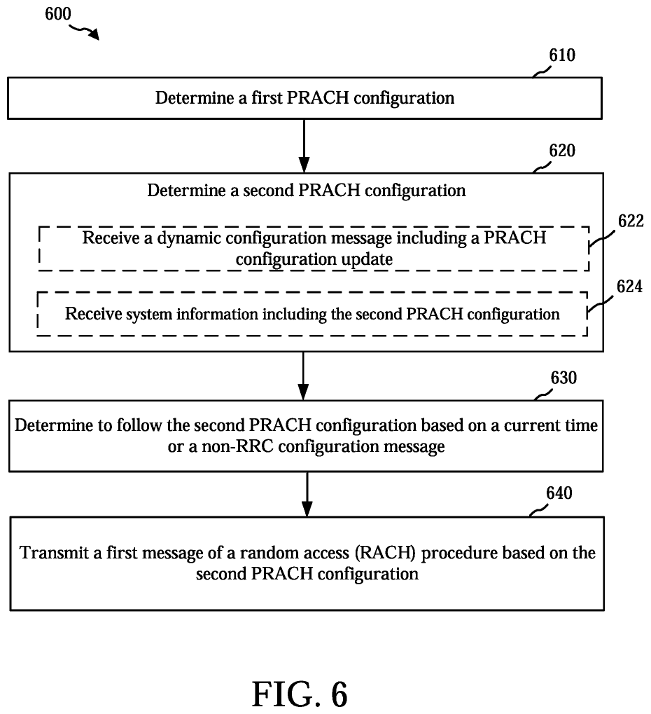

FIG. 6 is a flowchart of a method 600 of wireless communication. The method 600 may be performed by a UE (e.g., the UE 104 including the UE random access component 140 or the apparatus 702/702′). Optional aspects are illustrated with a dashed line. The method 600 may be performed by a UE (such as the UE 104, which may include the memory 360 and which may be the entire UE 104 or a component of the UE 104 such as the UE random access component 140, TX processor 368, the RX processor 356, or the controller/processor 359). The method 600 may allow the UE 104 to dynamically select a PRACH configuration for a RACH procedure.

At block 610, the method 600 may include determining a first PRACH configuration. In an aspect, for example, the UE 104, the RX processor 356 and/or the controller/processor 359 may execute UE random access component 140 and/or the system configuration component 142 to determine the first PRACH configuration. For example, the system configuration component 142 may receive the system information 460 including the first PRACH configuration. In some implementations, the system configuration component 142 may receive the RRC configuration 462 including one or more parameters of the first PRACH configuration. Accordingly, the UE 104, the RX processor 356, and/or the controller/processor 359 executing the UE random access component 140 and/or the system configuration component 142 may provide means for determining a first PRACH configuration.

At block 620, the method 600 may include determining a second PRACH configuration. In an aspect, for example, the UE 104, the RX processor 356 and/or the controller/processor 359 may execute UE random access component 140 and/or the dynamic configuration component 144 to determining a second PRACH configuration. For example, at sub-block 622, the block 620 may include receiving a dynamic configuration message including a PRACH configuration update. For instance, the dynamic configuration component 144 may receive the dynamic configuration message 464 including the PRACH configuration update. The dynamic configuration message 464 may be one of a DCI, MAC-CE, or paging message. In some implementations, the second PRACH configuration is valid until a second PRACH configuration update is received (e.g., in another dynamic configuration message 464). In other implementations, the second PRACH configuration is valid during a period of time indicated by the PRACH configuration update. For example, the PRACH configuration update may indicate a number of hours or minutes during which the second PRACH configuration is valid. In some implementations, the PRACH configuration update includes a set of PRACH configuration parameters. That is, the dynamic configuration message 464 may carry the values of the PRACH configuration parameters for the second PRACH configuration. In other implementations, the PRACH configuration update indicates a configured PRACH configuration. For example, the dynamic configuration message 464 may include an index identifying a preconfigured PRACH configuration. For instance, the preconfigured PRACH configuration may be defined by system information 460, or be defined in a standards document or regulation. As another example, at sub-block 624, the block 620 may optionally include receiving system information including the second PRACH configuration. For example, the dynamic configuration component 144 may receive the system information 460, which may include the second PRACH configuration. Accordingly, the system information 460 may include both the first PRACH configuration and the second PRACH configuration. In some implementations, the first PRACH configuration and the second PRACH configuration follow a time pattern. Accordingly, the UE 104, the RX processor 356, and/or the controller/processor 359 executing the UE random access component 140 and/or the dynamic configuration component 144 may provide means for determining a second PRACH configuration.

At block 630, the method 600 may include determining to follow the second PRACH configuration based on a current time or the dynamic configuration message. In an aspect, for example, the UE 104, the RX processor 356 and/or the controller/processor 359 may execute the UE random access component 140 and/or the selection component 146 to determine to follow the second PRACH configuration based on a current time or a dynamic configuration message. For instance, where the first PRACH configuration and the second PRACH configuration follow a time pattern, the selection component 146 may determine which PRACH configuration corresponds to the current time. The current time may be network time. The UE 104 may be synchronized with the network, for example, based on a SSB. Similarly, where the dynamic configuration message 464 defines an applicable time period for the second PRACH configuration, the selection component 146 may determine whether the current time is within the applicable time period. As another example, where the dynamic configuration message 464 indicates that the second PRACH configuration is applicable until a further configuration is received, the selection component 146 may determine that the second PRACH configuration is applicable based on the most recent dynamic configuration message 464. Accordingly, the UE 104, the RX processor 356, and/or the controller/processor 359 executing the UE random access component 140 and/or the selection component 146 may provide means for determining to follow the second PRACH configuration based on a current time or the dynamic configuration message.

At block 640, the method 600 may include transmitting a first message of a RACH procedure based on the second PRACH configuration. In an aspect, for example, the UE 104, the TX processor 368 and/or the controller/processor 359 may execute UE random access component 140 and/or the preamble component 148 to transmit a first message of a RACH procedure based on the second PRACH configuration. For example, the preamble component 148 may transmit the Msg1 410 or the MsgA PRACH 540 based on the second PRACH configuration. Accordingly, the UE 104, TX processor 368, and/or the controller/processor 359 executing the UE random access component 140 and/or the preamble component 148 may provide means for transmitting a first message of a RACH procedure based on the second PRACH configuration.

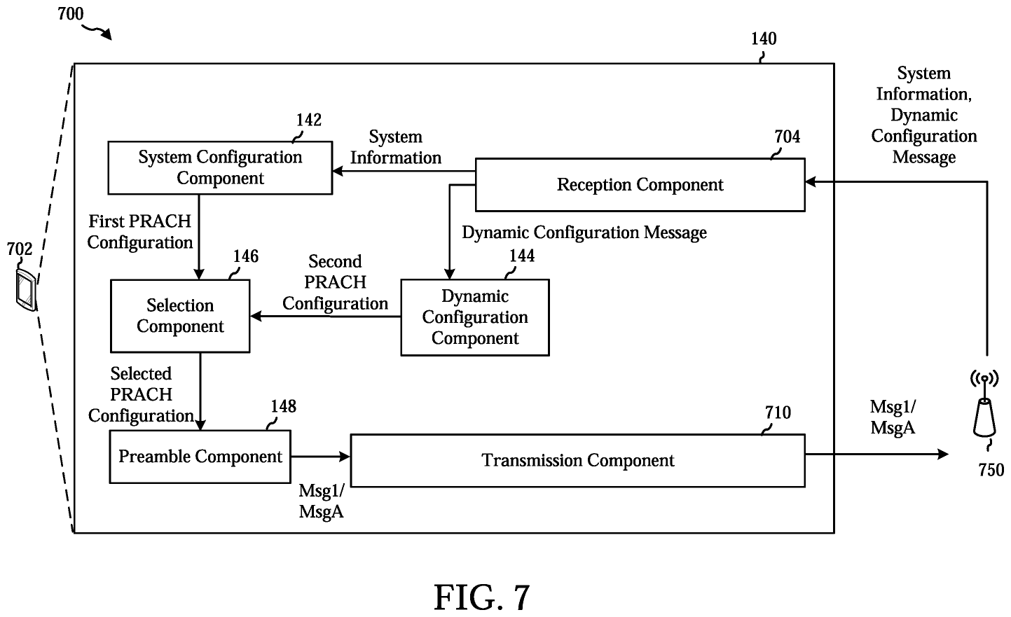

FIG. 7 is a conceptual data flow diagram 700 illustrating the data flow between different means/components in an example apparatus 702. The apparatus 702 may be a UE. The apparatus 702 may include the UE random access component 140. The apparatus 702 may include a reception component 704 that receives downlink signals such as system information 460 and/or dynamic configuration message 464 from a base station 750. The reception component 704 may provide the system information 460 to the system configuration component 142 and provide the dynamic configuration message 464 to the dynamic configuration component 144.

The system configuration component 142 may receive the system information 460 from the reception component 704. The system configuration component 142 may determine a first PRACH configuration based on the system information 460. In some implementations, the system configuration component 142 may also receive a RRC message and determine or update the first PRACH configuration based on the RRC message. The system configuration component 142 may provide the first PRACH configuration to the selection component 146.

The dynamic configuration component 144 may receive the dynamic configuration message 464 from the reception component 704. The dynamic configuration component 144 may determine the second PRACH configuration based on the dynamic configuration message 464. For instance, the dynamic configuration message 464 may include the parameters of the second PRACH configuration. In another example, the dynamic configuration message 464 may include an index of the second PRACH configuration. The dynamic configuration component 144 may provide the second PRACH configuration to the selection component 146.

The selection component 146 may receive the first PRACH configuration from the system configuration component 142 and receive the second PRACH configuration from the dynamic configuration component 144. The selection component 146 may select between the first PRACH configuration and the second PRACH configuration based on a current time or the dynamic configuration message. For example, the selection component 146 may compare the current time to a defined applicable period of the second PRACH configuration to determine whether the second PRACH configuration is to be followed. As another example, the selection component 146 may determine that the second PRACH configuration is to be followed when the dynamic configuration message 464 indicates that the second PRACH configuration is applicable until a subsequent PRACH configuration is received. The selection component 146 may provide the selected PRACH configuration to the preamble component 148.

The preamble component 148 may receive the selected PRACH configuration from the selection component 146. The preamble component 148 may transmit a first message of a RACH procedure based on the second PRACH configuration. For example, the preamble component 148 may select a preamble for Msg1 or MsgA based on an indicated number of random access preambles or a number of contention based preambles. The preamble component 148 may also select resources (e.g., a RACH occasion) based on the number of RACH occasions in the frequency domain, the PRACH configuration index, and/or the number of SSBs per RACH occasion. The preamble component 148 may transmit the first message of the RACH procedure with the selected preamble on the selected resources via the transmission component 710.

The apparatus may include additional components that perform each of the blocks of the algorithm in the aforementioned flowchart of FIG. 6. As such, each block in the aforementioned flowchart of FIG. 6. may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

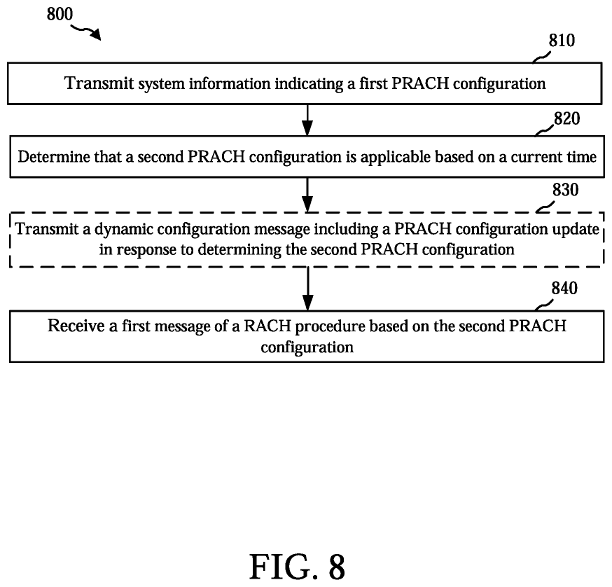

FIG. 8 is a flowchart of an example method 800 for receiving a first message of a RACH procedure based on a dynamic PRACH configuration. The method 800 may be performed by a base station (such as the base station 102, which may include the memory 376 and which may be the entire base station 102 or a component of the base station 102 such as the BS random access component 198, TX processor 316, the RX processor 370, or the controller/processor 375). The method 800 may be performed by the BS random access component 198 in communication with the UE random access component 140 of the UE 104.

At block 810, the method 800 may include transmitting system information indicating a first PRACH configuration. In an aspect, for example, the controller/processor 375, and/or the TX processor 316 may execute the BS random access component 198 and/or the system information component 906 to transmit system information indicating a first PRACH configuration. Accordingly, the base station 102, the controller/processor 375, and/or the TX processor 316 executing the BS random access component 198 and/or the system information component 906 may provide means for transmitting system information indicating a first PRACH configuration.

At block 820, the method 800 may include determining that a second PRACH configuration is applicable based on a current time. In an aspect, for example, the controller/processor 375, and/or the TX processor 316 may execute the BS random access component 198 and/or the selection component 908 to determine that a second PRACH configuration is applicable based on a current time. Accordingly, the base station 102, the controller/processor 375, and/or the TX processor 316 executing the BS random access component 198 and/or the selection component 908 may provide means for determining that a second PRACH configuration is applicable based on a current time.

At block 830, the method 800 may include transmitting a dynamic configuration message including a PRACH configuration update in response to determining the second PRACH configuration. In an aspect, for example, the controller/processor 375, and/or the TX processor 316 may execute the BS random access component 198 and/or the dynamic messaging component 914 to transmit the dynamic configuration message 464 including a PRACH configuration update in response to determining the second PRACH configuration. For example, the dynamic configuration message 464 may be one of a DCI, MAC-CE, or paging message. In some implementations, the second PRACH configuration is valid until a second PRACH configuration update is transmitted. In other implementations, the second PRACH configuration is valid during a period of time indicated by the PRACH configuration update. In some implementations, the PRACH configuration update includes a set of PRACH configuration parameters. In other implementations, the PRACH configuration update indicates a configured PRACH configuration. Accordingly, the base station 102, the controller/processor 375, and/or the TX processor 316 executing the BS random access component 198 and/or the dynamic messaging component 914 may provide means for transmitting a dynamic configuration message including a PRACH configuration update in response to determining the second PRACH configuration.

At block 840, the method 800 may include receiving a first message of a RACH procedure based on the second PRACH configuration. In an aspect, for example, the controller/processor 375, and/or the TX processor 316 may execute the BS random access component 198 and/or the preamble receiver component 912 to receive a first message of a RACH procedure based on the second PRACH configuration. Accordingly, the base station 102, the controller/processor 375, and/or the TX processor 316 executing the BS random access component 198 and/or the preamble receiver component 912 may provide means for receiving a first message of a RACH procedure based on the second PRACH configuration.

FIG. 9 is a conceptual data flow diagram 900 illustrating the data flow between different means/components in an example apparatus 902. The apparatus 902 may be a base station. The apparatus 902 may include the BS random access component 198. The apparatus 902 may include a reception component 904 that receives uplink signals from a UE 950 including a first message of a RACH procedure (e.g., a preamble).

The apparatus 902 may include a system information component 906 that transmits system information indicating at least a first PRACH configuration. The first PRACH configuration may be configured by a network operator. The system information component 906 may generate system information blocks (SIBs) including the parameters of the first PRACH configuration. In some implementations, the system information component 906 may additionally transmit a second PRACH configuration. For example, the system information component 906 may generate an additional SIB including the parameters of the second PRACH configuration. The second PRACH configuration may be configured by the network operator. In some implementations, the second PRACH configuration is configured with a time period for which the second PRACH configuration is applicable. The system information component 906 may periodically transmit the SIBs via the transmission component 910.

The apparatus 902 may include a selection component 908. The selection component 908 may select between the first PRACH configuration and the second PRACH configuration. For example, the selection component 908 may determine that the second PRACH configuration is applicable based on a current time. For instance, the selection component 908 may determine that the current time corresponds to the time period of which the second PRACH configuration is applicable. The selection component 908 may provide an indication of the selected PRACH configuration to the preamble receiver component 912. In some implementations, the selection component 908 may provide the second PRACH configuration or an indication thereof to a dynamic messaging component 914.

The dynamic messaging component 914 may receive the second PRACH configuration from the selection component 908. The dynamic messaging component 914 may generate a dynamic configuration message 464 based on the second PRACH configuration. The dynamic messaging component 914 may transmit the dynamic configuration message 464 via the transmission component 910.

The preamble receiver component 912 may receive a first message of a RACH procedure based on the selected PRACH configuration. The first message may be, for example, either Msg1 410 or MsgA 540. The preamble receiver component 912 may monitor resources based on the selected PRACH configuration. The preamble receiver component 912 may determine whether a received signal includes one or more of the preambles indicated by the selected PRACH configuration.

The apparatus 902 may include additional components that perform each of the blocks of the algorithm in the aforementioned flowcharts of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

### SOME FURTHER EXAMPLE CLAUSES

Implementation examples are described in the following numbered clauses:

1. A method of wireless communication, comprising:
determining a first physical random access channel (PRACH) configuration;
determining a second PRACH configuration;
determining to follow the second PRACH configuration based on a current time or a dynamic configuration message; and

transmitting a first message of a random access (RACH) procedure based on the second PRACH configuration.

2. The method of clause 1, wherein determining the second PRACH configuration comprises receiving the dynamic configuration message including a PRACH configuration update.

3. The method of clause 2, wherein the dynamic configuration message is one of a downlink control information (DCI), media access control (MAC) control element (CE), or paging message.

4. The method of clause 3, wherein the second PRACH configuration is valid until a second PRACH configuration update is received.

5. The method of clause 3, wherein the second PRACH configuration is valid during a period of time indicated by the PRACH configuration update.

6. The method of clause 2, wherein the PRACH configuration update includes a set of PRACH configuration parameters.

7. The method of clause 2, wherein the PRACH configuration update indicates a configured PRACH configuration.

8. The method of clause 1, wherein the first PRACH configuration and the second PRACH configuration follow a time pattern.

9. The method of clause 1, wherein the first PRACH configuration is based on a system information block.

10. The method of clause 1, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

11. The method of clause 1, wherein the second PRACH configuration is for a 4-step RACH procedure or a 2-step RACH procedure.

12. A method of wireless communication, comprising:
transmitting system information indicating a first physical random access channel (PRACH) configuration;

determining that a second PRACH configuration is applicable based on a current time; and
receiving a first message of a random access (RACH) procedure based on the second PRACH configuration.

13. The method of clause 12, further comprising transmitting a dynamic configuration message including a PRACH configuration update in response to determining the second PRACH configuration.

14. The method of clause 13, wherein the dynamic configuration message is one of a downlink control information (DCI), media access control (MAC) control element (CE), or paging message.

15. The method of clause 14, wherein the second PRACH configuration is valid until a second PRACH configuration update is transmitted.

16. The method of clause 14, wherein the second PRACH configuration is valid during a period of time indicated by the PRACH configuration update.

17. The method of clause 13, wherein the PRACH configuration update includes a set of PRACH configuration parameters.

18. The method of clause 13, wherein the PRACH configuration update indicates a configured PRACH configuration.

19. The method of clause 12, wherein the first PRACH configuration and the second PRACH configuration follow a time pattern.

20. The method of clause 12, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

21. The method of clause 12, wherein the second PRACH configuration is for a 4-step RACH procedure or a 2-step RACH procedure.

22. An apparatus for wireless communication, comprising:

a memory storing computer-executable instructions; and

at least one processor coupled with the memory and configured to execute the computer-executable instructions to:

determine a first physical random access channel (PRACH) configuration;

determine a second PRACH configuration;
determine to follow the second PRACH configuration based on a current time or a dynamic configuration message; and

transmit a first message of a random access (RACH) procedure based on the second PRACH configuration.

23. The apparatus of clause 22, wherein the at least one processor is configured to receive the dynamic configuration message including a PRACH configuration update.

24. The apparatus of clause 23, wherein the dynamic configuration message is one of a downlink control information (DCI), media access control (MAC) control element (CE), or paging message.

25. The apparatus of clause 24, wherein the second PRACH configuration is valid until a second PRACH configuration update is received.

26. The apparatus of clause 24, wherein the second PRACH configuration is valid during a period of time indicated by the PRACH configuration update.

27. The apparatus of clause 23, wherein the PRACH configuration update includes a set of PRACH configuration parameters.

28. The method of clause 23, wherein the PRACH configuration update indicates a configured PRACH configuration.

29. The apparatus of clause 22, wherein the first PRACH configuration and the second PRACH configuration follow a time pattern.

30. The apparatus of clause 22, wherein the first PRACH configuration is based on a system information block.

31. The apparatus of clause 22, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

32. The apparatus of clause 2, wherein the second PRACH configuration is for a 4-step RACH procedure or a 2-step RACH procedure.

33. An apparatus for wireless communication, comprising:

a memory storing computer-executable instructions; and

at least one processor coupled with the memory and configured to execute the computer-executable instructions to:
transmit system information indicating a first physical random access channel (PRACH) configuration;
determine that a second PRACH configuration is applicable based on a current time; and
receive a first message of a random access (RACH) procedure based on the second PRACH configuration.

34. The apparatus of clause 33, wherein the at least one processor is configured to transmit a dynamic configuration message including a PRACH configuration update in response to determining the second PRACH configuration.

35. The apparatus of clause 34, wherein the dynamic configuration message is one of a downlink control information (DCI), media access control (MAC) control element (CE), or paging message.

36. The apparatus of clause 35, wherein the second PRACH configuration is valid until a second PRACH configuration update is transmitted.

37. The apparatus of clause 35, wherein the second PRACH configuration is valid during a period of time indicated by the PRACH configuration update.

38. The apparatus of clause 34, wherein the PRACH configuration update includes a set of PRACH configuration parameters.

39. The apparatus of clause 34, wherein the PRACH configuration update indicates a configured PRACH configuration.

40. The apparatus of clause 33, wherein the first PRACH configuration and the second PRACH configuration follow a time pattern.

41. The apparatus of clause 33, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

42. The apparatus of clause 33, wherein the second PRACH configuration is for a 4-step RACH procedure or a 2-step RACH procedure.

43. An apparatus for wireless communication, comprising:
means for determining a first physical random access channel (PRACH) configuration; means for determining a second PRACH configuration;
means for determining to follow the second PRACH configuration based on a current time or a dynamic configuration message; and
means for transmitting a first message of a random access (RACH) procedure based on the second PRACH configuration.

44. The apparatus of clause 43, wherein the means for determining the second PRACH configuration is configured to receive the dynamic configuration message including a PRACH configuration update.

45. The apparatus of clause 44, wherein the dynamic configuration message is one of a downlink control information (DCI), media access control (MAC) control element (CE), or paging message.

46. The apparatus of clause 45, wherein the second PRACH configuration is valid until a second PRACH configuration update is received.

47. The apparatus of clause 45, wherein the second PRACH configuration is valid during a period of time indicated by the PRACH configuration update.

48. The apparatus of clause 44, wherein the PRACH configuration update includes a set of PRACH configuration parameters.

49. The apparatus of clause 44, wherein the PRACH configuration update indicates a configured PRACH configuration.

50. The apparatus of clause 43, wherein the first PRACH configuration and the second PRACH configuration follow a time pattern. 51. The apparatus of clause 43, wherein the first PRACH configuration is based on a system information block.

52. The apparatus of clause 43, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

53. The apparatus of clause 43, wherein the second PRACH configuration is for a 4-step RACH procedure or a 2-step RACH procedure.

54. An apparatus for wireless communication, comprising:
means for transmitting system information indicating a first physical random access channel (PRACH) configuration;
means for determining that a second PRACH configuration is applicable based on a current time; and
means for receiving a first message of a random access (RACH) procedure based on the second PRACH configuration.

55. The apparatus of clause 54, further comprising means for transmitting a dynamic configuration message including a PRACH configuration update in response to determining the second PRACH configuration.

56. The apparatus of clause 55, wherein the dynamic configuration message is one of a downlink control information (DCI), media access control (MAC) control element (CE), or paging message.

57. The apparatus of clause 56, wherein the second PRACH configuration is valid until a second PRACH configuration update is transmitted.

58. The apparatus of clause 56, wherein the second PRACH configuration is valid during a period of time indicated by the PRACH configuration update.

59. The apparatus of clause 55, wherein the PRACH configuration update includes a set of PRACH configuration parameters.

60. The apparatus of clause 55, wherein the PRACH configuration update indicates a configured PRACH configuration.

61. The apparatus of clause 54, wherein the first PRACH configuration and the second PRACH configuration follow a time pattern.

62. The apparatus of clause 54, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

63. The apparatus of clause 54, wherein the second PRACH configuration is for a 4-step RACH procedure or a 2-step RACH procedure.

64. A non-transitory computer-readable medium storing computer executable code, the code when executed by a processor causes the processor to:
determine a first physical random access channel (PRACH) configuration;
determining a second PRACH configuration;
determine to follow the second PRACH configuration based on a current time or a dynamic configuration message; and
transmit a first message of a random access (RACH) procedure based on the second PRACH configuration.

65. The non-transitory computer-readable medium of clause 64, wherein the code to determine the second PRACH configuration includes code to receive the dynamic configuration message including a PRACH configuration update.

66. The non-transitory computer-readable medium of clause 65, wherein the dynamic configuration message is one of a downlink control information (DCI), media access control (MAC) control element (CE), or paging message.

67. The non-transitory computer-readable medium of clause 66, wherein the second PRACH configuration is valid until a second PRACH configuration update is received.

68. The non-transitory computer-readable medium of clause 66, wherein the second PRACH configuration is valid during a period of time indicated by the PRACH configuration update.

69. The non-transitory computer-readable medium of clause 65, wherein the PRACH configuration update includes a set of PRACH configuration parameters.

70. The non-transitory computer-readable medium of clause 65, wherein the PRACH configuration update indicates a configured PRACH configuration.

71. The non-transitory computer-readable medium of clause 64, wherein the first PRACH configuration and the second PRACH configuration follow a time pattern.

72. The non-transitory computer-readable medium of clause 64, wherein the first PRACH configuration is based on a system information block.

73. The non-transitory computer-readable medium of clause 64, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

74. The non-transitory computer-readable medium of clause 64, wherein the second PRACH configuration is for a 4-step RACH procedure or a 2-step RACH procedure.

75. A non-transitory computer-readable medium storing computer executable code, the code when executed by a processor causes the processor to:
transmitting system information indicating a first physical random access channel (PRACH) configuration;
determining that a second PRACH configuration is applicable based on a current time; and
receiving a first message of a random access (RACH) procedure based on the second PRACH configuration.

76. The non-transitory computer-readable medium of clause 75, further comprising code to transmit a dynamic configuration message including a PRACH configuration update in response to determining the second PRACH configuration.

77. The non-transitory computer-readable medium of clause 76, wherein the dynamic configuration message is one of a downlink control information (DCI), media access control (MAC) control element (CE), or paging message.

78. The non-transitory computer-readable medium of clause 77, wherein the second PRACH configuration is valid until a second PRACH configuration update is transmitted.

79. The non-transitory computer-readable medium of clause 77, wherein the second PRACH configuration is valid during a period of time indicated by the PRACH configuration update.

80. The non-transitory computer-readable medium of clause 76, wherein the PRACH configuration update includes a set of PRACH configuration parameters.

81. The non-transitory computer-readable medium of clause 76, wherein the PRACH configuration update indicates a configured PRACH configuration.

82. The non-transitory computer-readable medium of clause 75, wherein the first PRACH configuration and the second PRACH configuration follow a time pattern.

83. The non-transitory computer-readable medium of clause 75, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

84. The non-transitory computer-readable medium of clause 75, wherein the second PRACH configuration is for a 4-step RACH procedure or a 2-step RACH procedure.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, comprising:
determining a first physical random access channel (PRACH) configuration;
determining a second PRACH configuration;
determining to follow the second PRACH configuration based on a current time or a dynamic configuration message; and
transmitting a first message of a random access (RACH) procedure based on the second PRACH configuration.

2. The method of claim 1, wherein determining the second PRACH configuration comprises receiving the dynamic configuration message including a PRACH configuration update.

3. The method of claim 2, wherein the dynamic configuration message is one of a downlink control information (DCI), media access control (MAC) control element (CE), or paging message.

4. The method of claim 3, wherein the second PRACH configuration is valid until a second PRACH configuration update is received.

5. The method of claim 3, wherein the second PRACH configuration is valid during a period of time indicated by the PRACH configuration update.

6. The method of claim 2, wherein the PRACH configuration update includes a set of PRACH configuration parameters.

7. The method of claim 2, wherein the PRACH configuration update indicates a configured PRACH configuration.

8. The method of claim 1, wherein the first PRACH configuration and the second PRACH configuration follow a time pattern.

9. The method of claim 1, wherein the first PRACH configuration is based on a system information block.

10. The method of claim 1, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

11. The method of claim 1, wherein the second PRACH configuration is for a 4-step RACH procedure or a 2-step RACH procedure.

12. A method of wireless communication, comprising:
transmitting system information indicating a first physical random access channel (PRACH) configuration;
determining that a second PRACH configuration is applicable based on a current time; and
receiving a first message of a random access (RACH) procedure based on the second PRACH configuration.

13. The method of claim 12, further comprising transmitting a dynamic configuration message including a PRACH configuration update in response to determining the second PRACH configuration.

14. The method of claim 13, wherein the dynamic configuration message is one of a downlink control information (DCI), media access control (MAC) control element (CE), or paging message.

15. The method of claim 14, wherein the second PRACH configuration is valid until a second PRACH configuration update is transmitted.

16. The method of claim 14, wherein the second PRACH configuration is valid during a period of time indicated by the PRACH configuration update.

17. The method of claim 13, wherein the PRACH configuration update includes a set of PRACH configuration parameters.

18. The method of claim 13, wherein the PRACH configuration update indicates a configured PRACH configuration.

19. The method of claim 12, wherein the first PRACH configuration and the second PRACH configuration follow a time pattern.

20. The method of claim 12, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

21. The method of claim 12, wherein the second PRACH configuration is for a 4-step RACH procedure or a 2-step RACH procedure.

22. An apparatus for wireless communication, comprising:
a memory storing computer-executable instructions; and
at least one processor coupled with the memory and configured to execute the computer-executable instructions to:
determine a first physical random access channel (PRACH) configuration;
determine a second PRACH configuration;
determine to follow the second PRACH configuration based on a current time or a dynamic configuration message; and
transmit a first message of a random access (RACH) procedure based on the second PRACH configuration.

23. The apparatus of claim 22, wherein the at least one processor is configured to receive the dynamic configuration message including a PRACH configuration update.

24. The apparatus of claim 23, wherein the dynamic configuration message is one of a downlink control information (DCI), media access control (MAC) control element (CE), or paging message.

25. The apparatus of claim 24, wherein the second PRACH configuration is valid until a second PRACH configuration update is received.

26. The apparatus of claim 24, wherein the second PRACH configuration is valid during a period of time indicated by the PRACH configuration update.

27. The apparatus of claim 23, wherein the PRACH configuration update includes a set of PRACH configuration parameters.

28. The apparatus of claim 23, wherein the PRACH configuration update indicates a configured PRACH configuration.

29. The apparatus of claim 22, wherein the second PRACH configuration includes one or more of: a number of RACH occasions in a frequency domain, a PRACH configuration index, a number of random access preambles, a number of contention-based preambles, or a number of synchronization signal blocks (SSB) per RACH occasion.

30. An apparatus for wireless communication, comprising:
a memory storing computer-executable instructions; and
at least one processor coupled with the memory and configured to execute the computer-executable instructions to:
transmit system information indicating a first physical random access channel (PRACH) configuration;
determine that a second PRACH configuration is applicable based on a current time; and
receive a first message of a random access (RACH) procedure based on the second PRACH configuration.
